(19) United States
(12) Patent Application Publication
(10) Pub. No.: US 2008/0005447 A1
(43) Pub. Date: Jan. 3, 2008

(54) Dynamic mapping of guest addresses by a virtual machine monitor

(76) Inventors: Sebastian Schoenberg, Hillsboro, OR (US); Andrew Anderson, Hillsboro, OR (US); Steven M. Bennett, Hillsboro, OR (US); Rajesh Sankaran, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/479,731

(22) Filed: Jun. 30, 2006

(51) Int. Cl. G06F 21/00

(52) U.S. Cl. 711/6

(57) ABSTRACT

In a virtualization system comprising a guest machine, a host machine, and a virtual machine monitor (VMM), the host machine further including a processor including hardware support for virtualization the hardware support for virtualization at least in part to control operation of the guest machine, the VMM dynamically installing a mapping for a guest address to be accessed by the VMM in a page table of the VMM, prior to the VMM accessing the guest physical address.

### BACKGROUND

Virtualization enables a single host machine with hardware and software support for virtualization to present an abstraction of the host, such that the underlying hardware of the host machine appears as one or more independently operating virtual machines. Each virtual machine may therefore function as a self-contained platform. Often, virtualization technology is used to allow multiple guest operating systems and/or other guest software to coexist and execute apparently simultaneously and apparently independently on multiple virtual machines while actually physically executing on the same hardware platform. A virtual machine may mimic the hardware of the host machine or alternatively present a different hardware abstraction altogether.

Virtualization systems may include a virtual machine monitor (VMM) which controls the host machine. The VMM provides guest software operating in a virtual machine with a set of resources (e.g., processors, memory, IO devices). The VMM may map some or all of the components of a physical host machine into the virtual machine, and may create fully virtual components, emulated in software in the VMM, which are included in the virtual machine (e.g., virtual IO devices). The VMM may thus be said to provide a “virtual bare machine” interface to guest software. The VMM uses facilities in a hardware virtualization architecture to provide services to a virtual machine and to provide protection from and between multiple virtual machines executing on the host machine.

As guest software executes in a virtual machine, certain instructions executed by the guest software (e.g., instructions accessing peripheral devices) would normally directly access hardware, were the guest software executing directly on a hardware platform. In a virtualization system supported by a VMM, these instructions may cause a transition to the VMM, referred to herein as a virtual machine exit. The VMM handles these instructions in software in a manner suitable for the host machine hardware and host machine peripheral devices consistent with the virtual machines on which the guest software is executing. Similarly, certain interrupts and exceptions generated in the host machine may need to be intercepted and managed by the VMM or adapted for the guest software by the VMM before being passed on to the guest software for servicing. The VMM then transitions control to the guest software and the virtual machine resumes operation. The transition from the VMM to the guest software is referred to herein as a virtual machine entry.

As is well known, a process executing on a machine on most operating systems may use a linear address space, which is an abstraction of the underlying physical memory system. As is known in the art, the term linear when used in the context of memory management e.g. “linear address,” “linear address space,” or “linear memory address” refers to the well known technique of a processor-based system, generally in conjunction with an operating system, presenting an abstraction of underlying physical memory to a process executing on a processor-based system. For example, a process may access a contiguous and linearized address space abstraction which is mapped to non-linear and non-contiguous physical memory by the underlying operating system. It should be noted that the term “virtual memory” is often used in the art to denote a linear address space as described above. The term “virtual memory” is not used hereinafter to avoid confusion with “virtual” as used in the context of machine virtualization.

### BRIEF DESCRIPTION OF THE DRAWINGS

FIG. 1 depicts the relationship between process and physical memory.

FIG. 2 depicts abstractly the relationship between virtual machines and a host machine in one embodiment.

FIG. 3 depicts a high level structure of a virtual machine environment in one embodiment.

FIG. 4 depicts the processing flow of a VMM accessing guest memory in an embodiment.

FIG. 5 depicts the processing flow of a VMM accessing guest memory in an embodiment.

### DETAILED DESCRIPTION

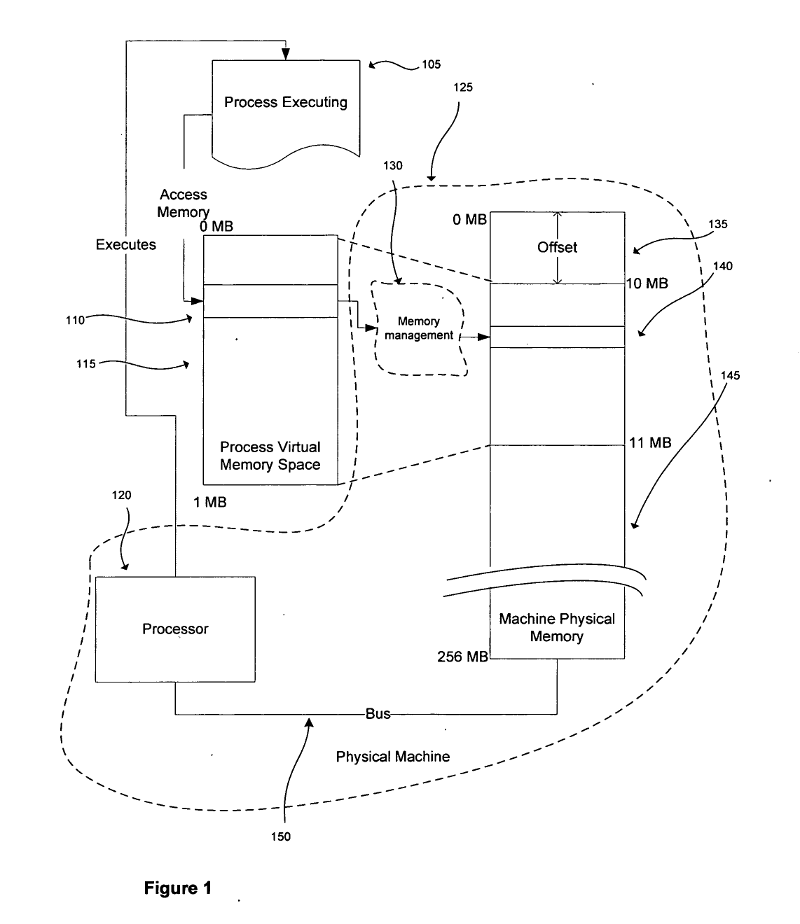

FIG. 1 shows a process executing on a processor-based system which incorporates a processor and a memory communicatively coupled to the processor by a bus. With reference to FIG. 1, when a process 105 references a memory location 110 in its linear address space 115 (process linear memory space), a reference to an actual address 140 in the physical memory 145 of the machine 125 (machine physical memory) is generated by memory management unit 130, which may be implemented in hardware (sometimes incorporated into the processor 120) and software (generally in the operating system of the machine). Memory management unit 130, among other functions, maps a location in the linear address space to a location in physical memory of the machine. As shown in FIG. 1, a process may have a different view of memory from the actual memory available in the physical machine. In the example depicted in FIG. 1, the process operates in a linear address space from 0 to 1 MB which is actually mapped by the memory management hardware and software into a portion of the physical memory from 10 to 11 MB; to compute a physical address from a process space address, an offset 135 may be added to the process virtual address. More complex mappings from process virtual memory space to physical memory are possible, for example, the physical memory corresponding to process virtual memory may be divided into parts such as pages and be interleaved with frames from other processes.

Linear Memory is customarily divided into pages, each page containing a known amount of data, varying across implementations, e.g. a page may contain 4096 bytes of memory. As memory locations are referenced by the executing process, they are translated into frames. In a typical machine, memory management maps a page in process linear memory to a frame in machine physical memory. In general, memory management may use a page table to specify the frame's location corresponding to a process' page location.

One aspect of managing guest software in a virtual machine environment is the management of memory. Handling memory management actions taken by the guest software executing in a virtual machine creates complexity for a controlling system such as a virtual machine monitor. Consider for example a system in which two virtual machines execute via virtualization on a host machine implemented on a 32-bit IA-32 Intel® Architecture platform (IA-32), which is described in the IA-32 Intel® Architecture Software Developer's Manual (IA-32 documentation). The IA-32 platform may include IA-32 page tables implemented as part of an IA-32 processor. Further, assume that each virtual machine itself presents an abstraction of an IA-32 machine to the guest software executing thereon. Guest software executing on each virtual machine may make references to a guest process' linear memory address, which in turn is translated by the guest machine's memory management system to a guest-physical memory address. Guest-physical memory itself may be implemented by a further mapping in host-physical memory through a VMM and/or the virtualization subsystem in hardware on the host processor. Thus, references to guest memory by guest processes or the guest operating system, including for example references to guest IA-32 page-table control registers, must then be intercepted by the VMM and/or virtualization subsystem in hardware because they cannot be directly passed on to the host machine's IA-32 page table without further reprocessing, as the guest-physical memory does not, in fact, correspond directly to host-physical memory but is rather further remapped through the virtualization system of the host machine.

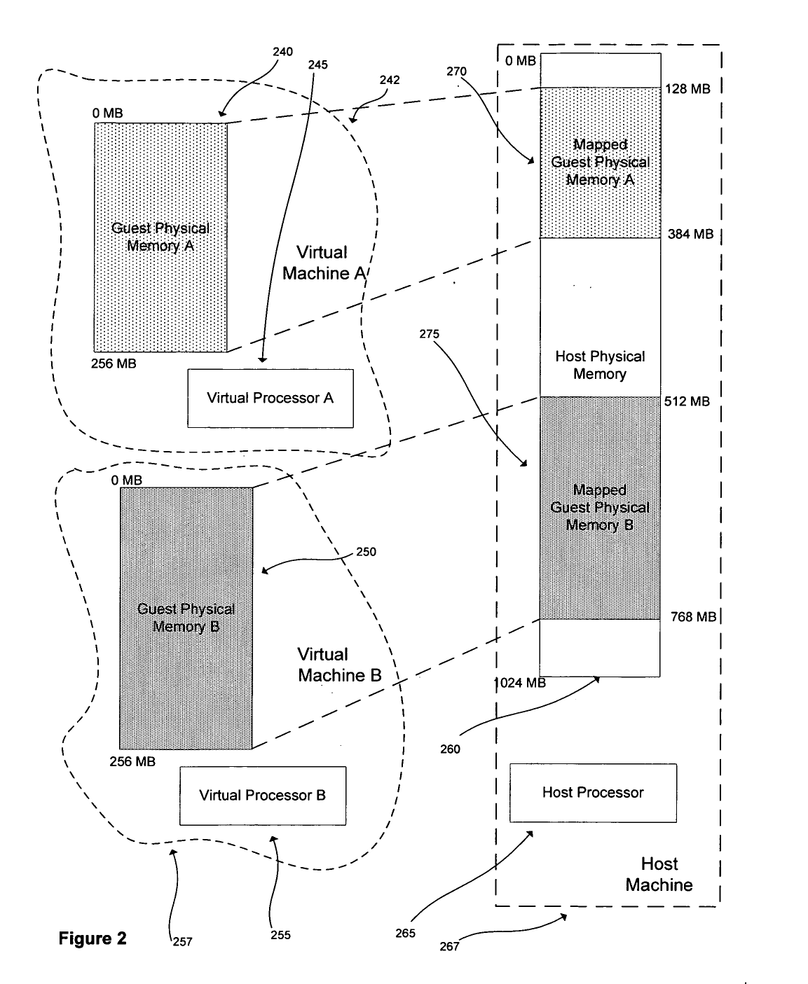

FIG. 2: FIG. 2 depicts the relationship between one or more virtual machines executing on a host machine with specific regard to the mapping of guest memory in one embodiment. FIG. 2 illustrates how guest-physical memory is remapped through the virtualization system of the host machine. Each virtual machine such as virtual machine A, 242, and virtual machine B, 257, presents a virtual processor 245 and 255 respectively to guest software running on the virtual machines. Each machine provides an abstraction of physical memory to the guest operating system or other guest software, guest-physical memories 240 and 250, respectively. As guest software executes on the virtual machines 242 and 257, it is actually executed by the host machine 267 on host processor 265 utilizing host-physical memory 260.

As shown in FIG. 2, in this embodiment, the physical memory-backed portion of the guest-physical memory address space 240 which is presented as a physical memory space starting at address 0 in virtual machine A, 242, is mapped to some contiguous region 270 in host-physical memory 260. Similarly, guest-physical memory 250 in virtual machine B, 257, is mapped to a different portion 275 of host-physical memory 260. As shown in FIG. 2, the host machine might have 1024 MB of host-physical memory. If each virtual machine 242 and 257 is assigned 256 MB of memory, one possible mapping might be that virtual machine A, 242, is assigned the range 128-384 MB and virtual machine B, 257, is assigned the range 512-768 MB. Both virtual machines 242 and 257 reference a guest-physical address space of 0-256 MB. Only the VMM is aware that each virtual machine's address space maps to different portions of the host-physical address space.

A VMM in a shared-address space operates using the same address space as an executing guest process, but may protect a portion of the linear address space using another available mechanism, e.g., a segmentation limit mechanism. Consequently the guest-linear mappings may be a strict subset of the mappings for a component of the VMM executing within the same address space as the guest process. One example of such a VMM architecture is Xen, see for example, Ian Pratt et al., Xen 3.0 and the Art of Virtualization, a presentation of the University of Cambridge Computer Laboratory, available at www.cl.cam.ac.uk/Research/SRG/netos/xen/architecture.html on the World Wide Web, and provided in an Information Disclosure with this Application. In such systems, VMM access to the guest-linear address is provided as a by-product of guest page-table virtualization.

Unlike a shared-address space VMM, a dedicated address space VMM uses linear mappings which are not a strict superset of guest mappings. Consequently use of the linear address space is far less constrained and mapping decisions are not made as a result of page-table virtualization.

The virtual machines and memory mapping shown in FIG. 2 are only one representation of one embodiment, in other embodiments, the actual number of virtual machines executing on a host machine may vary from one to many; the actual memory sizes of the host machine and the virtual machines may vary and be variable from virtual machine to virtual machine. The example depicts a simple, contiguous allocation of memory to virtual machines. In a more general case, the physical memory pages allocated to a virtual machine may not be contiguous and might be distributed in the host-physical memory interleaved with each other and with pages belonging to the VMM and to other host processes.

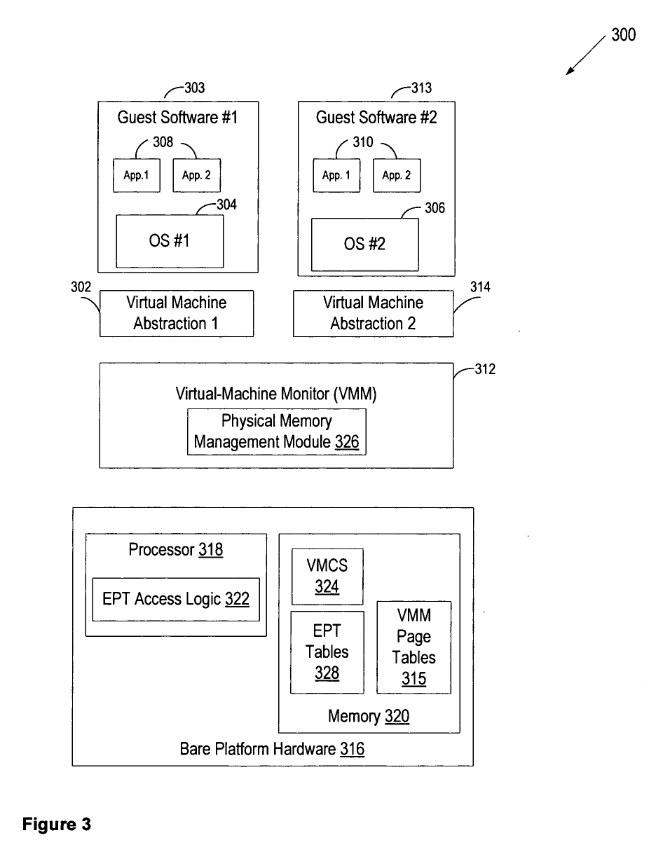

FIG. 3: FIG. 3 illustrates one embodiment of a virtual-machine environment 300. In this embodiment, a processor-based platform 316 may execute a VMM 312. The VMM, though typically implemented in software, may emulate and export a virtual bare machine interface to higher level software. Such higher level software may comprise a standard OS, a real-time OS, or may be a stripped-down environment with limited operating-system functionality and may not include OS facilities typically available in a standard OS in some embodiments. Alternatively, for example, the VMM 312 may be run within, or using the services of, another VMM. VMMs may be implemented, for example, in hardware, software, firmware or by a combination of various techniques in some embodiments. In at least one embodiment, one or more components of the VMM may execute in one or more virtual machines and one or more components of the VMM may execute on the bare platform hardware as depicted in FIG. 3. The components of the VMM executing directly on the bare platform hardware are referred to herein as host components of the VMM.

The platform hardware 316 may be a personal computer (PC), mainframe, handheld device such as a personal digital assistant (PDA) or “smart” mobile phone, portable computer, set top box, or another processor-based system. The platform hardware or host machine 316 includes at least a processor 318 and memory 320. Processor 318 may be any type of processor capable of executing programs, such as a microprocessor, digital signal processor, microcontroller, or the like. The processor may include microcode, programmable logic or hard coded logic for execution in embodiments. Although FIG. 3 shows only one such processor 318, there may be one or more processors in the system in an embodiment. Additionally, processor 318 may include multiple cores, support for multiple threads, or the like. Memory 320 can comprise a hard disk, a floppy disk, random access memory (RAM), read only memory (ROM), flash memory, any combination of the above devices, or any other type of machine medium readable by processor 318 in various embodiments. Memory 320 may store instructions and/or data for performing program execution and other method embodiments.

The VMM 312 presents to guest software an abstraction of one or more virtual machines, which may provide the same or different abstractions to the various guests. FIG. 3 shows two virtual machines, 302 and 314. Guest software such as guest software 303 and 313 running on each virtual machine may include a guest OS such as a guest OS 304 or 306 and various guest software applications 308 and 310. Guest software 303 and 313 may access physical resources (e.g., processor registers, memory and I/O devices) within the virtual machines on which the guest software 303 and 313 is running and to perform other functions. For example, the guest software 303 and 313 expects to have access to all registers, caches, structures, I/O devices, memory and the like, according to the architecture of the processor and platform presented in the virtual machine 302 and 314.

In one embodiment, the VMM 312 may operate with paging enabled in the host machine 316. Thus, the VMM operates with a linear view of host memory and uses a set of page tables 315 in the memory of the host machine that is available for VMM use to map its linear view of host linear memory to host physical memory.

In one embodiment, the processor 318 controls the operation of the virtual machines 302 and 314 in accordance with data stored in a virtual machine control structure (VMCS) 324. The VMCS 324 is a structure that may contain state of guest software 303 and 313, state of the VMM 312, execution control information indicating how the VMM 312 wishes to control operation of guest software 303 and 313, information controlling transitions between the VMM 312 and a virtual machine, etc. The processor 318 reads information from the VMCS 324 to determine the execution environment of the virtual machine and to constrain its behavior. In one embodiment, the VMCS 324 is stored in memory 320. In some embodiments, multiple VMCS structures are used to support multiple virtual machines.

The VMM 312 may need to manage the physical memory accessible by guest software running in the virtual machines 302 and 314. To support physical memory management in one embodiment, the processor 318 provides an extended page table (EPT) mechanism. The EPT mechanism is described in pending U.S. patent application Ser. No. 11/036,736 entitled “Virtualizing Physical Memory in a Virtual Machine System” Attorney Docket Number P20462 ('736 application), assigned to the assignee of the present invention. In the embodiment, the VMM 312 may include a physical memory management module 326 that provides values for fields associated with physical memory virtualization that may need to be provided before transition of control to the virtual machine 302 or 314. These fields are collectively referred to as EPT controls. EPT controls may include, for example, an EPT enable indicator specifying whether the EPT mechanism should be enabled and one or more EPT table configuration controls indicating the form and semantics of the physical memory virtualization mechanism. These will be discussed in detail below. Additionally, in one embodiment, EPT tables 328 indicate the physical address translation and protection semantics which the VMM 312 may place on guest software 303 and 313.

In one embodiment, the EPT controls are stored in the VMCS 324. Alternatively, the EPT controls may reside in a processor 318, a combination of the memory 320 and the processor 318, or in any other storage location or locations. In one embodiment, separate EPT controls are maintained for each of the virtual machines 302 and 314. Alternatively, the same EPT controls are maintained for both virtual machines and are updated by the VMM 312 before each virtual machine entry.

In one embodiment, the EPT tables 328 are stored in memory 320. Alternatively, the EPT tables 328 may reside in the processor 318, a combination of the memory 320 and the processor 318, or in any other storage location or locations. In one embodiment, separate EPT tables 328 are maintained for each of the virtual machines 302 and 314. Alternatively, the same EPT tables 328 are maintained for both virtual machines 302 and 314 and are updated by the VMM 312 before each virtual machine entry. In some embodiments, EPT tables may differ for virtual processors within a single VM.

In one embodiment, the processor 318 includes EPT access logic 322 that is responsible for determining whether the EPT mechanism is enabled based on the EPT enable indicator. If the EPT mechanism is enabled, the processor translates guest-physical addresses to host-physical addresses-based on the EPT controls and EPT tables 328.

In one embodiment, page-table virtualization is implemented through the use of shadow page tables. Rather than instructing a processor to directly use the page tables maintained by the guest operating system, the VMM may instead generate an alternate set of page tables, called shadow page tables, which govern address translation during typical guest execution. The shadow page tables are derived from the guest page tables, but apply relocation and additional attribute changes as required by the VMM. Additional details of representative attribute changes can be found in Neiger, et al., Virtual Translation Lookaside Buffer, U.S. Pat. No. 6,907,600; and Andrew Anderson, A Method and Apparatus for Supporting Address Translation in a Virtual Machine Environment, U.S. patent application Ser. No. 11/045,524.

Shadow page tables may be used to translate from the guest-linear address space to the host-physical address space, or from the guest-physical address space to the host-physical address space, depending on the VM's operating mode. During operation with shadow page tables, the VMM must configure the VMCS to cause transitions to the VMM on privileged state modifications that modify paging state. In one embodiment utilizing shadow page tables, the VMM must examine at least some portion of page-fault exits to determine if the access should fault given the current contents of the guest page tables. Such examination may require walking some portion of the guest page table, which are addressed in the guest-physical address space. Modifications of the guest-physical address space may also be required to update guest-page table fields such as the accessed and dirty bits.

In one embodiment utilizing shadow page tables, the VMM must emulate instructions which modify guest page tables. In such an embodiment the emulation of these instructions requires frequent references to the guest-linear address space.

While VMMs employing shadow page tables do not maintain hardware structures to specify the effective guest-physical to host-physical translations for a VM, they must maintain a data structure which describes translation and privilege information used in the translation process.

In one embodiment, in which the system 300 includes multiple processors or multi-threaded processors, each of the logical processors is associated with a separate EPT access logic 322, and the VMM 312 configures the EPT tables 328 and EPT controls for each of the logical processors.

In an embodiment, the guest operating systems such as 304 and 306 in FIG. 3 operate with memory access controlled by a different set of page tables in the corresponding virtual machine abstractions (302 and 314 respectively), from the page tables 315 used by the VMM. However, the VMM may often need to access data in the guest physical memory space, for example, when a virtual device presented by a virtual machine executes a direct memory access (DMA) to guest memory. The VMM may need to emulate the result of the DMA by accessing guest physical memory. These accesses begin with a guest physical address which is used by the DMA-capable virtual device. Similarly when the guest accesses a memory mapped virtual device, the VMM may need to access guest physical memory in order to emulate such access. These accesses begin with a guest linear address which is used by the guest process, which are then translated first by the guest page tables to a guest physical address.

Because the VMM itself uses page table mediated access, it needs generally to install mappings for these guest physical addresses in its page tables to be able to access the corresponding host physical addresses. A known method of installing the mappings is to pre-populate the VMM page tables with mappings required for the portion of guest physical address space that is actually backed by physical memory on the host machine. Thus, a 1:1 mapping that maps a guest physical address to a host physical address is pre-installed in the VMM page table for each guest physical address backed by physical memory. Alternatively in one embodiment, the VMM page tables may be pre-populated with mappings for only certain portions of the guest physical address space which is used to manage (virtual) devices. In this case, a number of non-contiguous regions may be mapped.

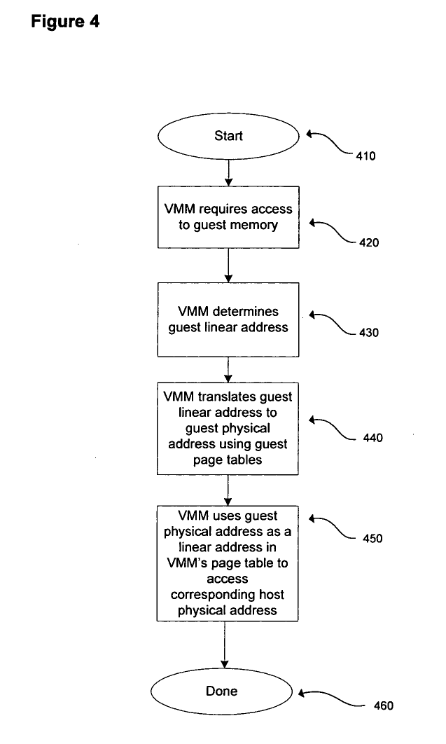

FIG. 4 In this scenario, depicted in the flowchart of FIG. 4, the VMM takes the following known actions to access a guest linear address, 420: first, the VMM determines the guest linear address to be accessed, for example, to emulate the effect of a memory mapped I/O access by the guest at that guest linear address, at 430. Next, the VMM translates the guest linear address to a guest physical address using the guest page tables at 440. The VMM's page tables are then used by the VMM to translate the guest physical address to a host physical address for the actual access at 450, terminating the process at 460. Thus, the guest physical address is used like a linear address in the VMM address space as far as page table lookup is concerned.

The page tables of the VMM in the scenario of FIG. 4 thus are initialized with mappings from the pages of guest physical memory to host physical memory. In general, the process of generating a mapping from the guest physical address to a host physical address may involve a lookup of the Extended Paging Tables (EPT) in some virtualized systems, as described with reference to FIG. 3 above. In general, the functionality of the EPT is more fully described in the '736 application referenced above. More specifically, the EPT provides a mapping from guest physical memory to host physical memory in the context of a virtualized system. Thus, the initialization of the VMM's page tables may in turn depend on lookups to the EPT.

In the known implementation described above, therefore, the page tables of the VMM must include space for all of the guests' physical page addresses that are backed by physical memory; and thus a significant amount of storage is required, reducing the memory available for guest execution; VMM complexity is increased; and performance degraded depending on the size of the guest physical address space.

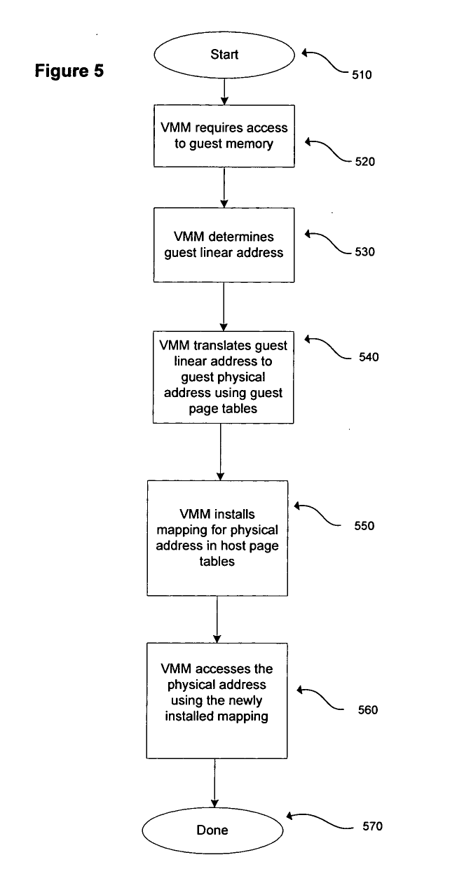

Some of these aspects of the above described of implementation of VMM access to guest linear memory may be avoided in some embodiments. A generalized flowchart depicting these embodiments appears in FIG. 5, starting at 510. As before, when the VMM requires access to guest memory 520, it first determines' the guest linear address to be accessed, 530. Once again, the guest linear address must be translated to a guest physical address via a lookup of the guest page tables, at 540. Next, in contrast to the flow depicted in FIG. 4, the VMM in some embodiments installs a mapping for the guest physical address to be accessed in the VMM's page tables dynamically, generally immediately prior to the access to the address, at 550. As before, this mapping may involve a lookup of the EPT to translate the guest physical address into a host physical address. Once the dynamically installed mapping is in place, the VMM may then access the address on the host using the recently installed mapping at 560, and then the process is complete at 570. In some embodiments, invalidation by OS on that page may be required if, for example, TLBs may cache invalid or not present mappings.

Many variations on the flow depicted in FIG. 5 exist. In particular, the block 550 may be implemented in a variety of ways. In one exemplary embodiment, a method termed “lazy population” is used. In this embodiment, the VMM page table is initialized without any, or only a few mappings for the guest physical address space. On each impending access to the guest address space, the required mapping may be installed shortly prior to the access and then guest memory is accessed as described above using a guest physical address as a linear address in the VMM page table. Alternatively, the VMM may attempt to access the guest physical address and cause a page fault in response to which the entry may be loaded into the page table. In either case, this mechanism may reduce the memory footprint of the VMM page tables because it is unlikely that substantial portions of the guest physical memory will be accessed directly by the VMM. In some situations, this mechanism may also cause additional latency due to page faults or because extra checking prior to an access by the VMM to guest physical memory is required to ensure that a mapping for the access exists in the page table of the VMM or to install it if the mapping does not exist.

In another embodiment, the VMM may allocate a pool or set of linear addresses for use in accessing guest physical memory. For each linear address allocated, the VMM allocates a page-table entry (PTE), which is initially set to indicate that a mapped page is not present for that linear address. This may prevent the translation lookaside buffer (TLB) from speculatively caching a mapping for the corresponding region of the VMM's linear memory. On each required access to guest physical memory, the VMM then allocates the next available and unallocated PTE in the set and uses it for guest physical access. The various relevant fields in the PTE such as page-frame number, type and attributes of various types are set at about the same time as or before the “present” bit or flag being set in the PTE. When all the entries in the set of linear addresses have been used, the VMM recovers them by executing an invalidate page (INVLPG in the IA-32 architecture) instruction or its equivalent on all entries. Variations on this technique may include the use of another instruction that has the same effect as an INVLPG or its equivalent but invalidates all of the entries with one instruction, such as for example, in the IA-32 case, a move to one of the control registers such as CR3 in the page table; and the use of a large number of entries in the pool so that invalidations are infrequent. This method has a small memory footprint and improved average memory latency, although some variability occurs due to the need to invalidate entries periodically If other operations such as the transition from a guest to the VMM also cause invalidations of the translations, the VMM may reuse the slots after each such transition.

A specific case of the above approach may be used in another embodiment, with only one entry in the set of linear addresses. That is, in this approach, the VMM allocates exactly one fixed linear address for accesses to guest physical memory. Each time the VMM needs to access the guest's memory, the PTE for the fixed linear address is updated to refer to the physical address required. This requires that the PTE be invalidated after each access to guest physical memory and that the PTE be updated before each such access. While the memory footprint required for this approach is minimal, because only one PTE is used, the latency is higher because every access requires an invalidation and update.

Accesses to guest memory by the VMM, as described herein, may be made using a mapping based either on a guest-linear addresses or guest-physical addresses. The mapping that is put in place prior to the access in general would depend on whether the VMM requires access to an address in the guest space based on a guest physical address or a guest linear address. While examples here and in the sequel may refer to the VMM addressing a guest linear address or to the VMM accessing a guest physical addresses, these are merely exemplary and thus, a specific reference herein to accessing a guest-linear or guest-physical address should not be construed as limiting.

In the preceding description, for purposes of explanation, numerous specific details are set forth in order to provide a thorough understanding of the described embodiments, however, one skilled in the art will appreciate that many other embodiments may be practiced without these specific details. In particular references are made to specific details of the IA-32 architecture, its registers and instructions, among other details. However, as one in the art will readily recognize, the embodiments described above may readily be adapted to other processor architectures and instruction sets as is known.

Some portions of the detailed description above are presented in terms of algorithms and symbolic representations of operations on data bits within a processor-based system. These algorithmic descriptions and representations are the means used by those skilled in the art to most effectively convey the substance of their work to others in the art. The operations are those requiring physical manipulations of physical quantities. These quantities may take the form of electrical, magnetic, optical or other physical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

In the description of the embodiments, reference may be made to accompanying drawings. In the drawings, like numerals describe substantially similar components throughout the several views. Other embodiments may be utilized and structural, logical, and electrical changes may be made. Moreover, it is to be understood that the various embodiments, although different, are not necessarily mutually exclusive. For example, a particular feature, structure, or characteristic described in one embodiment may be included within other embodiments.

Further, a design of an embodiment that is implemented in a processor may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, data representing a hardware model may be the data specifying the presence or absence of various features on different mask layers for masks used to produce the integrated circuit. In any representation of the design, the data may be stored in any form of a machine-readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) that constitute or represent an embodiment.

Embodiments may be provided as a program product that may include a machine-readable medium having stored thereon data which when accessed by a machine may cause the machine to perform a process according to the claimed subject matter. The machine-readable medium may include, but is not limited to, floppy diskettes, optical disks, DVD-ROM disks, DVD-RAM disks, DVD-RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media/machine-readable medium suitable for storing electronic instructions. Moreover, embodiments may also be downloaded as a program product, wherein the program may be transferred from a remote data source to a requesting device by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the claimed subject matter. It will be apparent to those skilled in the art that many further modifications and adaptations can be made. The particular embodiments are not provided to limit the claimed subject matter but to illustrate it. The scope of the claimed subject matter is not to be determined by the specific examples provided above but only by the claims below.

What is claimed is:

1. A method comprising:
in a virtualization system comprising a guest machine, a host machine and a virtual machine monitor (VMM), the VMM
dynamically invalidating a first plurality of mappings in a page table of the VMM; and
dynamically installing a mapping for a guest address to be accessed by the VMM in the page table of the VMM, prior to the VMM accessing the guest physical address.

2. The method of claim 1 further comprising the VMM accessing the guest address using the mapping.

3. The method of claim 1 wherein the VMM dynamically installing the mapping further comprises:
initializing the page table of the VMM without the plurality of mappings;
installing the mapping into the page table prior to the VMM attempting to access the guest address.

4. The method of claim 1 wherein the VMM dynamically installing the mapping further comprises:
initializing the page table of the VMM without the plurality of mappings;
allowing the VMM to attempt to access the guest physical address; and
responding to a page fault caused by the VMM attempting to access the guest address by installing the mapping.

5. The method of claim 1 wherein the VMM dynamically installing the mapping further comprises:
allocating a set of linear address pages in its memory space;
initializing page table entries corresponding to the set of linear address pages in the page table of the VMM to indicate that for each linear address page allocated, no physical page is present; and
installing the mapping for the guest physical address into the page table immediately prior to the VMM attempting to access the guest address by checking if an unmapped linear address page is available; and
for each mapping,
selecting an unmapped linear address page; and
initializing the page table entry corresponding to the unmapped linear address page and to map the linear address page to the guest address.

6. The method of claim 1 wherein invalidating the first plurality of mappings further comprises using an operation to invalidate a plurality of the page table entries corresponding to the set of guest physical addresses

7. The method of claim 1 wherein the guest address is one of a guest linear address and a guest physical address.

8. A method comprising:
in a virtualization system comprising a guest machine, a host machine,
and a virtual machine monitor (VMM), the host machine further comprising a processor including hardware support for virtualization the hardware support for virtualization at least in part to control operation of the guest machine,
the VMM dynamically installing a mapping for a guest address to be accessed by the VMM in a page table of the VMM, prior to the VMM accessing the guest physical address.

9. The method of claim 8 further comprising the VMM accessing the guest physical address using the mapping.

10. The method of claim 8 wherein the VMM dynamically installing the mapping further comprises:
initializing the page table of the VMM without the mapping;
installing the mapping into the page table prior to the VMM attempting to access the guest physical address.

11. The method of claim 8 wherein the VMM dynamically installing the mapping further comprises:
initializing the page table of the VMM without the mapping;
allowing the VMM to attempt to access the guest physical address; and
responding to a page fault caused by the VMM attempting to access the guest physical address by installing the mapping.

12. The method of claim 8 wherein the VMM dynamically installing the mapping further comprises:
allocating a set of linear address pages in its memory space;
initializing page table entries corresponding to the set of linear address pages in the page table of the VMM to indicate that for each linear address page allocated, no physical page is present; and
installing a mapping for the guest physical address into the page table immediately prior to the VMM attempting to access the guest physical address by checking if an unmapped linear address page is available;
if an unmapped linear address page is not available, invalidating at least one of the page-table entries corresponding to the set of linear addresses to make an unmapped linear address page available;
selecting an unmapped linear address page; and
initializing the page table entry corresponding to the unmapped linear address page and to map the linear address page to the guest physical address.

13. The method of claim 12 wherein the set of guest linear address pages has one guest linear address page.

14. The method of claim 12 wherein invalidating at least one of the page table entries corresponding to the set of guest physical addresses to make an unmapped guest linear address page available further comprises using an operation to invalidate all of the page table entries corresponding to the set of guest physical addresses.

15. The method of claim 8 wherein the guest address is one of a guest linear address and a guest physical address.

16. A virtualization system comprising a guest machine, a host machine, and a virtual machine monitor (VMM), the host machine further comprising a processor including hardware support for virtualization the hardware support for virtualization at least in part to control operation of the guest machine,
the VMM to dynamically install a mapping for a guest address to be accessed by the VMM in a page table of the VMM, prior to the VMM accessing the guest physical address.

17. The system of claim 16 further comprising the VMM to access the guest physical address using the mapping.

18. The system of claim 16 wherein the VMM is further to
initialize the page table of the VMM without the mapping; and
install the mapping into the page table prior to the VMM attempting to access the guest physical address.

19. The system of claim 16 wherein the VMM is further to
initialize the page table of the VMM without the mapping;
allow an attempt to access the guest physical address; and
respond to a page fault caused by the VMM attempting to access the guest physical address by installing the mapping.

20. The system of claim 16 wherein the VMM is further to:
allocate a set of linear address pages in its memory space;
initialize page table entries corresponding to the set of linear address pages in the page table of the VMM to indicate that for each linear address page allocated, no physical page is present; and
install a mapping for the guest physical address into the page table immediately prior to the VMM attempting to access the guest physical address by
checking if an unmapped linear address page is available;
if an unmapped linear address page is not available, invalidating at least one of the page-table entries corresponding to the set of linear addresses to make an unmapped linear address page available;
selecting an unmapped linear address page; and
initializing the page table entry corresponding to the unmapped linear address page and to map the linear address page to the guest physical address.

21. The system of claim 20 wherein the set of guest linear address pages has one guest linear address page.

22. The system of claim 20 wherein invalidating at least one of the page table entries corresponding to the set of guest physical addresses to make an unmapped guest linear address page available further comprises using an operation to invalidate all of the page table entries corresponding to the set of guest physical addresses.

23. The system of claim 16 wherein the guest address is one of a guest linear address and a guest physical address.

24. A machine readable medium having stored thereon data that when accessed by a machine causes the machine to perform a method, the method comprising:
in a virtualization system comprising a guest machine, a host machine and a virtual machine monitor (VMM), the VMM
dynamically invalidating a first plurality of mappings in a page table of the VMM; and
dynamically installing a mapping for a guest address to be accessed by the VMM in the page table of the VMM, prior to the VMM accessing the guest physical address.

25. The machine readable medium of claim 24 wherein the method further comprises the VMM accessing the guest address using the mapping.

26. The machine readable medium of claim 24 wherein the VMM dynamically installing the mapping further comprises:
initializing the page table of the VMM without the plurality of mappings;
installing the mapping into the page table prior to the VMM attempting to access the guest address.

27. The machine readable medium of claim 24 wherein the VMM dynamically installing the mapping further comprises:
initializing the page table of the VMM without the plurality of mappings;
allowing the VMM to attempt to access the guest physical address; and
responding to a page fault caused by the VMM attempting to access the guest address by installing the mapping.

28. The machine readable medium of claim 24 wherein the VMM dynamically installing the mapping further comprises:
allocating a set of linear address pages in its memory space;
initializing page table entries corresponding to the set of linear address pages in the page table of the VMM to indicate that for each linear address page allocated, no physical page is present; and
installing the mapping for the guest physical address into the page table immediately prior to the VMM attempting to access the guest address by checking if an unmapped linear address page is available; and
for each mapping,
selecting an unmapped linear address page; and
initializing the page table entry corresponding to the unmapped linear address page and to map the linear address page to the guest address.

29. The machine readable medium of claim 24 wherein dynamically invalidating the first plurality of mappings further comprises using an operation to invalidate a plurality of the page table entries corresponding to the set of guest physical addresses

30. The machine readable medium of claim 24 wherein the guest address is one of a guest linear address and a guest physical address.

31. A machine readable medium having stored thereon data that when accessed by a machine causes the machine to perform a method, the method comprising:
in a virtualization system comprising a guest machine, a host machine, and a virtual machine monitor (VMM), the host machine further comprising a processor including hardware support for virtualization the hardware support for virtualization at least in part to control operation of the guest machine,
the VMM dynamically installing a mapping for a guest address to be accessed by the VMM in a page table of the VMM, prior to the VMM accessing the guest physical address.

32. The machine readable medium of claim 31 wherein the method further comprises the VMM accessing the guest physical address using the mapping.

33. The machine readable medium of claim 31 wherein the VMM dynamically installing the mapping further comprises:
initializing the page table of the VMM without the mapping;
installing the mapping into the page table prior to the VMM attempting to access the guest physical address.

34. The machine readable medium of claim 31 wherein the VMM dynamically installing the mapping further comprises:
initializing the page table of the VMM without the mapping;
allowing the VMM to attempt to access the guest physical address; and
responding to a page fault caused by the VMM attempting to access the guest physical address by installing the mapping.

35. The machine readable medium of claim 31 wherein the VMM dynamically installing the mapping further comprises:
allocating a set of linear address pages in its memory space;
initializing page table entries corresponding to the set of linear address pages in the page table of the VMM to indicate that for each linear address page allocated, no physical page is present; and
installing a mapping for the guest physical address into the page table immediately prior to the VMM attempting to access the guest physical address by checking if an unmapped linear address page is available;
if an unmapped linear address page is not available, invalidating at least one of the page-table entries corresponding to the set of linear addresses to make an unmapped linear address page available;
selecting an unmapped linear address page; and
initializing the page table entry corresponding to the unmapped linear address page and to map the linear address page to the guest physical address.

36. The machine readable medium of claim 35 wherein the set of guest linear address pages has one guest linear address page.

37. The machine readable medium of claim 35 wherein invalidating at least one of the page table entries corresponding to the set of guest physical addresses to make an unmapped guest linear address page available further comprises using an operation to invalidate all of the page table entries corresponding to the set of guest physical addresses.

38. The machine readable medium of claim 31 wherein the guest address is one of a guest linear address and a guest physical address.
